(19) United States
(12) Patent Application Publication
(10) Pub. No.: US 2007/0182723 A1
(43) Pub. Date: Aug. 9, 2007

(54) DISPLAY DEVICE

(75) Inventors: Takayuki Imai, Fukaya-shi (JP); Takashi Nakamura, Saitama-shi (JP); Hirotaka Hayashi, Fukaya-shi (JP); Norio Tada, Kumagaya-shi (JP); Hiroki Nakamura, Ageo-shi (JP); Miyuki Ishikawa, Kumagaya-shi (JP); Masahiro Yoshida, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/623,899

(22) Filed: Jan. 17, 2007

(30) Foreign Application Priority Data
Jan. 31, 2006 (JP) 2006-022745
Oct. 20, 2006 (JP) 2006-286371

(51) Int. Cl. G06F 3/042

(52) U.S. Cl. 345/175

(57) ABSTRACT

A display device includes a plurality of scan lines and each of a plurality of signal lines which are provided intersecting to each other; a plurality of display sections each disposed at an intersection of each of the plurality of scan lines and each of the plurality of signal lines; and a plurality of photo receivers each provided corresponding to each of the plural display sections so that the number of the disposed photo receivers would monotonically increase as the sizes of the photo receivers increase.

### CROSS REFERENCE OF THE RELATED APPLICATION

This application is based upon and claims the benefit of priority from the prior Japanese Patent Application No. 2006-022745, filed on Jan. 31, 2006 and No. 2006-286371, filed on Oct. 20, 2006; the entire contents of which are incorporated herein by reference.

### BACKGROUND OF THE INVENTION

1. Field of the Invention

The present invention relates to a display device for displaying images, particularly to a display device having photo receivers for receiving light and, further, to a technology of a display device having light sensors.

2. Description of the Related Art

Display devices such as liquid crystal displays have great advantages of thinness, lightweight and low power consumption. These display devices are widely used for displays of personal computers, mobile phones and the like. Furthermore, by adding an input function by use of a touch panel, a pen input or the like to the display devices, usage of the display devices has been expanded (refer to JP-A No. 2004-318819(KOKAI) for example).

Such a display device includes a display section and an image pickup section in each pixel. In addition to a display function of displaying images, the display device accomplishes a recognition function of reading an image of a target object to be recognized, such as a finger. This recognition function is carried out by detecting light such as environment light or backlight with a photo receiver, e.g., a photoelectric conversion element, provided to the image pickup section in a pixel.

Here, the light detection sensitivity of the image pickup section is proportional to the size (width) of the photo receiver. Since the photo receiver and the display section are integrally provided, the size of the display section limits the maximum size (maximum width) of the photo receiver. In addition, a microprocessing technology of manufacturing processes limits the minimum size (minimum width) of the photo receiver.

However, an image pickup section in a pixel is generally provided only in consideration of an aperture ratio, without consideration of the light detection sensitivity (the light detection sensitivity of a photo receiver). Thus, a large number of image pickup sections (photo receivers) having the low light detection sensitivity are sometimes provided, so that a recognition performance (reading performance) is deteriorated due to a decrease or an increase in the illumination intensity of detected light (outside light) such as environment light or backlight.

### SUMMARY OF THE INVENTION

An object of the present invention is to provide a display device which is capable of checking the lowering of a recognition performance, which would otherwise occur due to a decrease in the illumination intensity of detected light.

Another object of the present invention is to provide a display device which is capable of obtaining the information of light properly and securely regardless of whether the illumination intensity of outside light is high or low.

A first feature of embodiments of the present invention is that a display device includes a plurality of scan lines and each of a plurality of signal lines which are provided intersecting to each other; a plurality of display sections each disposed at an intersection of each of the plurality of scan lines and each of the plurality of signal lines; and a plurality of photo receivers each provided corresponding to each of the plural display sections so that the number of the disposed photo receivers would monotonically increase as the sizes of the photo receivers increase.

In the first feature of the embodiments of the present invention, the photo receivers are provided so that the number of disposed photo receivers would monotonically increase as the sizes of the photo receivers increase. With this configuration, it is possible to increase the entire light detection sensitivities while checking a decrease in the aperture ratio. This makes it possible to check the degradation of recognition performance due to a decrease in the illumination intensity of detected light.

A second feature of the embodiments of the present invention is that the display device includes: a display area in which a plurality of pixel areas including a plurality of pixels are disposed; a plurality of light sensors which are disposed in the pixel area, and which respectively have widths that increase in an arithmetical or geometrical series (hereinafter, simply referred to as “arithmetically or geometrically different widths”); and a plurality of light sensors each having a width greater than or equal to the maximum width of the arithmetically or geometrically different widths of the light sensors provided in the pixel area.

According to the second feature of the embodiments of the present invention, it is possible to adjust the light detection sensitivity of a pixel area (and a display area) by using the plurality of light sensors respectively having the arithmetically or geometrically different widths. In addition, it is possible to increase the light detection sensitivity of a pixel area (and a display area) can be increased by using the plurality of light sensors each having the width greater than or equal to the maximum width of the arithmetically or geometrically different widths. As a result, the display device is capable of obtaining information of light properly and securely regardless of whether the illumination intensity of the outside light is high or low.

A third feature of the embodiments of the present invention is that, in the display device, the number of light sensors having the widths greater than or equal to the maximum width of the arithmetically or geometrically different widths is not less than ⅓ of the number of light sensors having the arithmetically or geometrically different widths.

In the third feature of the embodiments of the present invention, the number of light sensors having widths greater than or equal to the maximum width of the arithmetically or geometrically different widths is not less than ⅓ of the number of light sensors having the arithmetically or geometrically different widths. This configuration can surely increase the light detection sensitivity of a pixel area.

A fourth feature of the embodiments of the present invention is that the plurality of light sensors respectively having the arithmetically or geometrically different widths and the plurality of light sensors each having a width greater than or equal to the maximum width of the arithmetically or geometrically different widths are disposed at random in the pixel area of the display device.

In the fourth feature of the embodiments of the present invention, the plurality of light sensors respectively having the arithmetically or geometrically different widths and the plurality of light sensors each having the width greater than or equal to the maximum width of the arithmetically or geometrically different widths are disposed at random in the pixel area. This configuration can check an effect of the non-uniformity of sensor properties generated in manufacturing processing, and prevent periodic unevenness from occurring at the time of capturing an image.

A fifth feature of the embodiments of the present invention is that the display device further includes a control circuit which adjusts an exposure time and/or a precharge voltage of the light sensors according to the illumination intensity of the outside light captured by the light sensors.

In the fifth feature of the embodiments of the present invention, the display device includes the control circuit which adjusts the exposure time and/or the precharge voltage of the light sensors according to the illumination intensity of the outside light captured by the light sensors. This configuration can surely prevent a black blur or a white blur from being formed in a picked-up image.

A sixth feature of the embodiments of the present invention is that the display device includes the plurality of pixels whose transmittances are equal.

In the sixth feature of the embodiments of the present invention, the transmittances of the plurality of pixels are equal. This makes it possible to avoid a degradation of display quality, such as luminance non-uniformity, which would occur in a case where a plurality of light sensors respectively having different widths are disposed.

A seventh feature of the embodiments of the present invention is that the pixel of the display device includes sub-pixels of red, green and blue, and that the plurality of light sensors respectively having the arithmetically or geometrically different widths and the plurality of light sensors each having a width greater than or equal to the maximum width of the arithmetically or geometrically different widths are provided to at least one of the sub-pixels of the display device.

An eighth feature of the embodiments of the present invention is that the display device includes the sub-pixels of red, green and blue, whose transmittances are equal to one another.

In the eighth feature of the embodiments of the present invention, the transmittances of the respective sub-pixels of red, green and blue are equal to one another Hence, the white balance of the display device can be prevented from deteriorating.

A ninth feature of the embodiments of the present invention is that the control circuit in the display device adjusts the exposure time and/or the precharge voltage of the light sensors by replacing at least a part of sensor signal values from a plurality of light sensors respectively having the arithmetically or geometrically different widths, with sensor signal values from a plurality of light sensors each having a width greater than or equal to the maximum width of the arithmetically or geometrically different widths.

In the ninth feature of the embodiments of the present invention, the control circuit adjusts the exposure time and/or the precharge voltage of the light sensors by replacing at least a part of sensor signal values from the plurality of light sensors respectively having the arithmetically or geometrically different widths with sensor signal values from the plurality of light sensors each having the width greater than or equal to the maximum width of the arithmetically or geometrically different widths. This configuration makes it possible to more surely recognize a target object being close to the display device even in a case where the illumination intensity of the outside light is low.

### BRIEF DESCRIPTION OF THE DRAWINGS

FIG. 1 is a plan view showing a diagrammatic configuration of a display device of a first embodiment of the present invention;

FIG. 2 is a circuit diagram showing a diagrammatic configuration of a pixel unit provided to the display device shown in FIG. 1;

FIG. 3 is a plan view showing a diagrammatic configuration of the pixel unit shown in FIG. 2;

FIG. 4 is an explanatory diagram explaining a relationship between the size and the gradation difference of photo receivers;

FIG. 5 is an explanatory view an explaining the gradation difference;

FIG. 6 is an explanatory diagram explaining a relationship between the size and the number of disposed photo receivers;

FIG. 7 is an explanatory diagram explaining a relationship between the illumination intensity and the gradation difference;

FIG. 8 is a configuration diagram showing a diagrammatic configuration of a display device of a second embodiment of the present invention;

FIG. 9 is a diagram showing a circuit configuration of a sensor integrated pixel;

FIG. 10 is a block diagram showing a circuit configuration of a control circuit;

FIG. 11 is a diagram showing a configuration of a selection circuit of a signal line drive circuit;

FIG. 12 is a plan view showing a configuration in which a plurality of light sensors of nine arithmetical level and a plurality of light sensors having widths equal to the maximum widths of the arithmetically different widths of the plurality of light sensors of nine arithmetical level are disposed in one pixel area, and in which a plurality of pixel areas are disposed in a display area unit that is a display area;

FIG. 13 is a front view of a light sensor;

FIG. 14 is a front view of a light sensor having the width larger than that of the light sensor shown in FIG. 13; and

FIG. 15 is a timing chart of processing operations of a sensor integrated pixel.

### DETAILED DESCRIPTION OF THE PREFERRED EMBODIMENTS

### First Embodiment

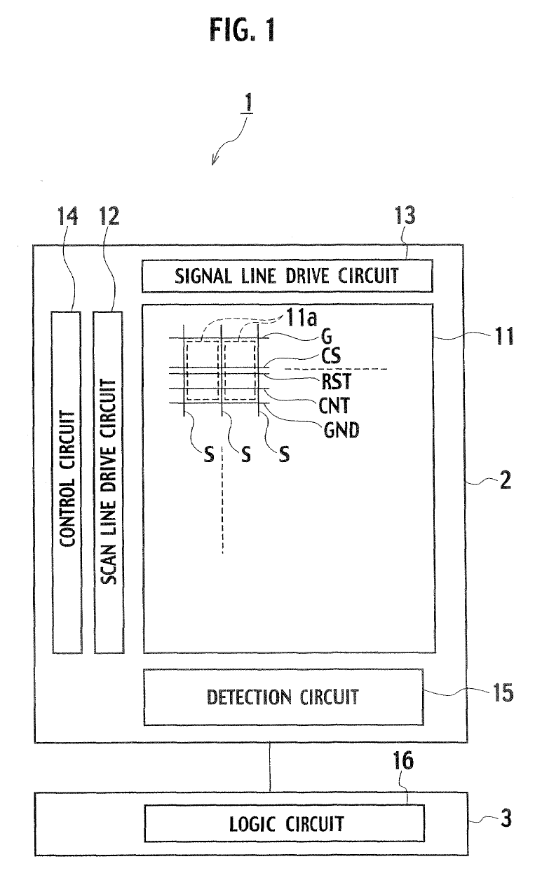

A first embodiment of the present invention is described by referring to FIGS. 1 to 7. A display device 1 of the first embodiment of the present invention is a device that displays an image based on image data, and that recognizes (using touch sense) a target recognition object such as a finger.

As shown in FIG. 1, this display device 1 includes an array substrate 2 formed of a transparent substrate such as a glass substrate, an external substrate 3 connected to the substrate 2 with a flexible cable or the like (not illustrated), and the like.

The array substrate 2 is provided with a pixel unit 11, a scan line drive circuit 12, a signal line drive circuit 13, a control circuit 14, a detection circuit 15 and the like. The pixel unit 11 includes a plurality of pixels 11a. One pixel 11a is disposed at each of the intersections of a plurality of scan lines G and a plurality of signal lines S, which are disposed intersecting one another. The scan line drive circuit 12 supplies a scan signal to each of the scan lines G. The signal line drive circuit 13 supplies a video signal to each of the signal lines S. The control circuit 14 supplies reset control signals to a plurality of reset lines RST disposed respectively in parallel to the scan lines G, and also supplies output control signals to a plurality of control lines CNT disposed respectively in parallel to the scan lines G. The detection circuit 15 reads an image of a target recognition object, and outputs an image-pickup signal corresponding to the image to the external substrate 3.

A logic circuit 16 is provided on the external substrate 3, and performs a display control, an image reading control, and the like. This logic circuit 16 supplies various kinds of signals such as control signals to the array substrate 2, and thereby performs a display control and an image capturing control.

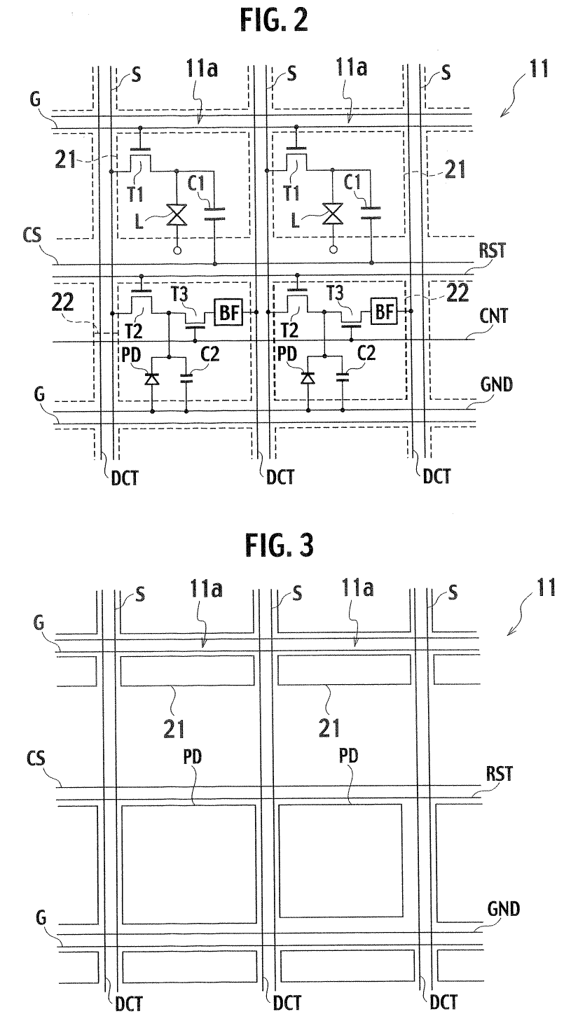

As shown in FIGS. 2 and 3, in the pixel unit 11, the plurality of scan lines G and the plurality of signal lines S are disposed intersecting one another. In addition, in the pixel unit 11, a plurality of auxiliary capacitance lines CS are disposed in parallel to the respective scan lines G. Moreover, in the pixel unit 11, the plurality of reset lines RST and the plurality of control lines CNT are disposed in parallel to the respective scan lines G. Moreover, in the pixel unit 11, a plurality of detection lines DCT are disposed in parallel to the respective signal lines S.

Each scan line G is connected to the scan line drive circuit 12, and each signal line S is connected to the signal line drive circuit 13. Furthermore, each reset line RST and each control line CNT are connected to the control circuit 14, and each detection line DCT is connected to the detection circuit 15.

One pixel 11a is disposed at each of the intersections of the scan lines G and the signal lines S. Each of the pixels 11a includes a display section 21 and an image pickup section (an optical sensor section) 22. Incidentally, in a case of the display device 1 for displaying color images, the pixel 11a has any one of color filters of red (R), green (G) and blue (B).

The display section 21 is configured of a picture transistor T1, a pixel capacitance L and an auxiliary capacitance C1. The picture transistor T1 is connected to the scan line G and the signal line S. The pixel capacitance L and the auxiliary capacitance C1 are connected to the transistors T1. The gate of the pixel transistor T1 is connected to the scan line G, the source thereof is connected to the signal line S, and the drain thereof is connected to the pixel capacitance L and the auxiliary capacitance C1. The other end of the auxiliary capacitance C1 is connected to the auxiliary capacitance line CS.

Note that, the pixel capacitance L is configure of a pixel electrode, an opposite electrode that is disposed opposite to the pixel electrode, and a display layer (not illustrated) such as a liquid crystal layer interposed between the pixel electrode and the opposite electrode. The opposite electrode is provided to an opposite substrate (not illustrated) that is disposed opposite to the array substrate 2 with the display layer interposed therebetween.

The image pickup section 22 is configured of a control transistor T2, a photo receiver PD, a sensor capacitance C2, a control transistor T3 and a buffer BF. The control transistor T2 is connected to the signal line S and the reset line RST. The photo receiver PD receives light and converts it into an electric signal. The sensor capacitance C2 is charged when the control transistor T2 is conducting. The control transistor T3 is connected to the control line CNT. The buffer BF is connected to the control transistor T2 and the sensor capacitance C2 with the control transistor T3 interposed therebetween.

The gate of the control transistor T2 is connected to the reset line RST, the source thereof is connected to the signal line S, and the drain thereof is connected to the photo receiver PD, the sensor capacitance C2 and the control transistor T3. The other ends of the photo receiver PD and the sensor capacitance C2 are connected to a ground line GND disposed in parallel to the scan line G. In addition, the photo receiver PD is connected in parallel to the sensor capacitance C2. The gate of the control transistor T3 is connected to the control line CNT, the source thereof is connected to the control transistor T2, the photo receiver PD and the sensor capacitance C2, and the drain thereof is connected to the buffer BF.

The control transistor T2 is a reset controller that controls switching on/off of electric charge supply to the sensor capacitance C2, and this control is based on a logic of the reset line RST, i.e., a reset control signal The photo receiver PD receives light such as environmental light or backlight, and converts it into an electric signal. The photo receiver PD is an element that causes the sensor capacitance C2 to discharge. As the photo receiver PD, for example, a photoelectric conversion element such as a photodiode is used.

The sensor capacitance C2 is an accumulation section which accumulates an electric charge depending on an electric signal obtained with the conversion by the photo receiver PD. The buffer BF is a storage section for temporarily storing the electric signal depending on the electric charge thus accumulated in the sensor capacitance C2. The control transistor T3 is a switching section which controls switching on/off of output of the electric signal stored in the buffer BF, and this control is based on a logic of the control line CNT, i.e., a output control signal.

Here, as the pixel transistor T1 and the respective control transistors T2 and T3, for example, polysilicon type thin-film transistors (TFT) or the like are used. As the photo receiver PD, for example, a photodiode, a phototransistor or the like is used. As the auxiliary capacitance C1 and the sensor capacitance C2, for example, condensers or the like are used.

The pixel unit 11 having the plurality of pixels 11a such as above has a display function of displaying a display screen (video data) supplied from the outside, and a recognition function of picking up an image of a recognition object such as a finger or a pen approaching the display screen, and thereby reading the image.

The scan line drive circuit 12 is a circuit which sequentially outputs scan signals to the respective scan lines G each outputted for each one horizontal period, i.e., for each video writing period in one horizontal period, and thus drives the scan lines G one by one. Here, the scan signal is a signal for causing the pixel transistor T1 to be driven (switched ON).

The signal line drive circuit 13 is a circuit which outputs a video signal to each of the signal lines S, in synchronization with the scan signal, and thus drives the signal lines S one by one. Here, the video signal is a signal which applies a voltage to the pixel capacitance L according to the video data.

The control circuit 14 sequentially outputs reset control signals to the respective reset lines RST, and sequentially drives the reset lines RST one by one. Here, the reset control signal is a signal for driving the control transistor T2. The control circuit 14 outputs output control signals to the respective control lines CNT, and sequentially drives the control lines CNT one by one. Here, the output control signal is a signal for driving the control transistor T3. The control circuit 14 such as above charges the sensor capacitance C2 until the voltage of the sensor capacitance C2 reaches a predetermined pre-charge voltage.

The detection circuit 15 is configured of an A/D (analog/digital) conversion circuit, an output circuit, a P/S (parallel/serial) conversion circuit, and the like. The detection circuit 15 converts a sensor output signal from the image pickup section 22 into a digital signal by use of the A/D conversion circuit; adjusts the amplitude or the like of the digital signal by use of the output circuit; and sends, an image pick-up signal, the thus adjusted digital signal one bit by one bit to the logic circuit 16 by use of the P/S conversion circuit. The output circuit adjusts the amplitude of the digital signal to the level depending on an interface of the logic circuit 16, or increases the amplitude to the level depending on a drive load until the digital signal reaches the logic circuit 16.

The logic circuit 16 receives the image pick-up signal from the detection circuit 15 of the array substrate 2; performs predetermined image processing on the image pick-up signal; and sends, to a host device, data that has been processed in image processing. In addition, the logic circuit 16 generates various kinds of control signals in response to control commands sent from the host device, and sends the various kinds of control signals thus generated to the array substrate 2.

Next, the light detection sensitivity of the image pickup section 22 is described.

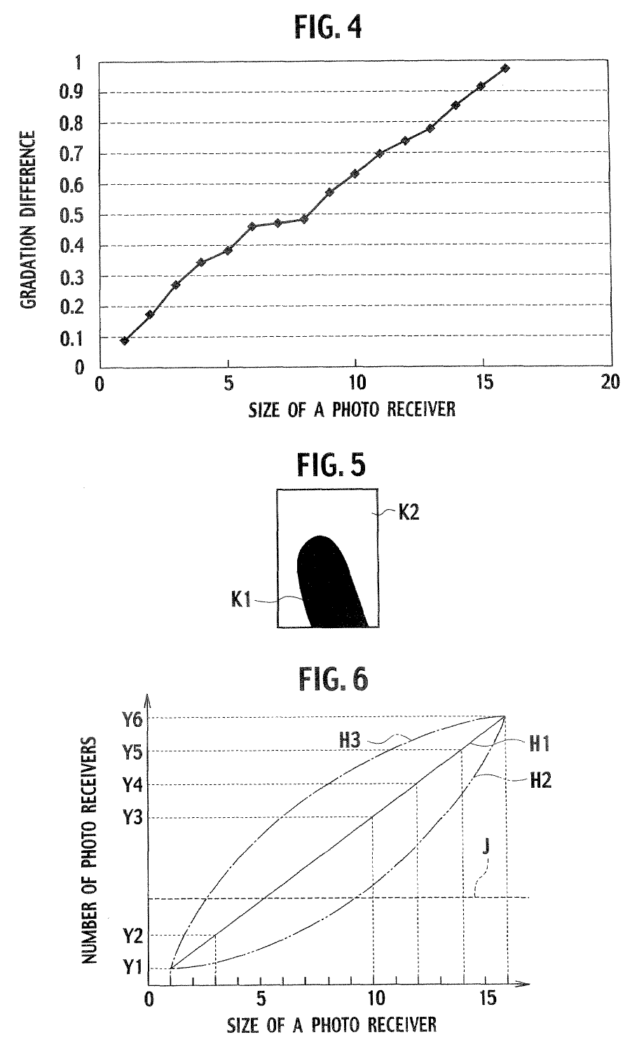

The light detection sensitivity of the image pickup section 22 is proportional to the size of the photo receiver PD (refer to FIG. 3) which receives light. For example, as shown in FIG. 4, the gradation difference increases as the size of the photo receiver PD increases. Note that, in FIG. 4, there are 16 levels, from level 1 to level 16, of the sizes of the photo receiver PD (the number of marked levels is 16). For example, the size of the photo receiver PD of level 1 is on the order of 4 μm. The size of the photo receiver PD increases by 4 μm on the level base. Then, the size of the photo receiver PD of level 16 is on the order of 64 μm.

A gradation difference is an index indicating whether or not a target recognition object such as a finger can be detected, i.e., one of indices of the light detection sensitivity. For example, as shown in FIG. 5, a gradation difference is a difference between an average gradation K1 of a portion showing the shadow of a finger that is a target recognition object, and an average gradation K2 of a portion showing the background other than the finger. The larger the gradation difference is, the higher the light detection sensitivity is. The higher light detection sensitivity allows the photo receiver PD to more easily discriminate between the shadow of a finger and the background.

Processing accuracy in processes of manufacturing the photo receiver PD limits the minimum size of the photo receiver PD, and the size of the display section 21 limits the maximum thereof (refer to FIG. 3). Note that, when the size of the photo receiver PD is increased in excess in order to increase the light detection sensitivity of the image pickup section 22, an aperture ratio substantially decreases. Accordingly, the size of the photo receiver PD is determined in consideration of a trade-off with the aperture ratio.

As shown in FIG. 6, the photo receivers PD are disposed so that the number of disposed photo receivers PD would monotonically increase with the increase in the size of the photo receiver PD (waveforms H1, H2, or H3). This configuration curbs a decrease of the aperture ratio due to an increase in the size of the photo receiver PD, and also enhances the light detection sensitivity of the entire display device 1.

The waveform H1 in FIG. 6 is a waveform in a case where the number of disposed photo receivers PD monotonically increases as a linear function according to the size of the photo receiver PD. The waveform H2 in FIG. 6 is a waveform in a case where the number of disposed photo receivers PD monotonically increases as an exponential function according to the size of the photo receiver PD. The waveform H3 in FIG. 6 is a waveform in a case where the number of disposed photo receivers PD monotonically increases as a logarithmic function according to the size of the photo receiver PD. A waveform J in FIG. 6 is a waveform in a case where the number of disposed photo receivers PD is constant regardless of the size of the photo receiver PD.

Here, in a case where the photo receivers PD of levels 1, 3, 10, 12, 14 and 16 are disposed, the numbers of disposed photo receivers PD of the respective levels are set to monotonically increase as does the waveform H1 in FIG. 6, for example. To be more precise, the number of disposed photo receivers PD of level 1 is set to Y1, and that of level 3 is set to Y2. In the same manner, the number of disposed photo receivers PD of level 10 is set to Y3; that of level 12 is set to Y4; that of level 14 is set to Y5; and that of level 16 is set to Y6. Here, a relational expression, 0<Y1<Y2<Y3<Y4<Y5<Y6 is established.

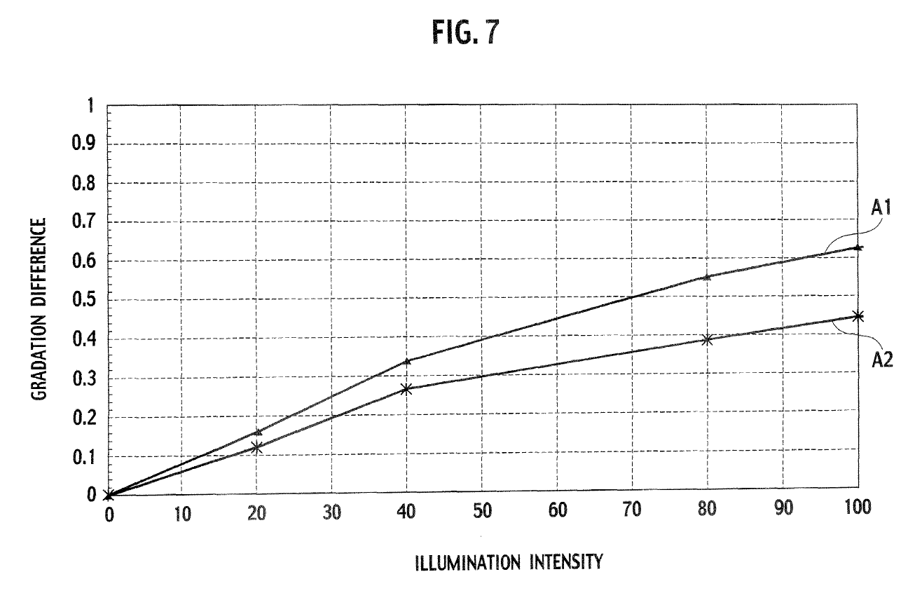

When the photo receivers PD of levels 1, 3, 10, 12, 14 and 16 are disposed up to the respective disposed numbers that are set for the photo receivers PD of the respective levels as is described above, a waveform A1 in FIG. 7 is obtained by finding the relationship between the luminance level and the gradation difference of the display device 1.

On the other hand, for example, when disposing the photo receivers PD of levels 1 to 16, the disposed numbers of photo receivers PD of all the levels are set constant as is shown with, for example, the waveform J in FIG. 6 (comparative example). When the photo receivers PD of levels 1 to 16 are disposed up to the constant number that is set for all the levels of photo receivers PD as is described above, a waveform A2 in FIG. 7 is obtained by finding the relationship between the luminance level and the gradation difference of the display device 1.

Here, a degree of gradation difference required to allow a target recognition object such as a finger to be detected is dependent on an algorithm of a detection determination program that is stored in an IC area of the logic circuit 16, that is, is dependent on a predetermined reference value of gradation difference. In a case where the reference value of gradation difference is, for example, 0.3, the margin of the luminance (a degree of margin) is expanded by about 15 lx, as is clear from the comparison of the waveform A1 with the waveform A2.

Accordingly, it can be seen that a decrease in the recognition performance due to a decrease in the luminance level of detected light is restrained when the photo receivers PD of levels 1, 3, 10, 12, 14 and 16 are disposed up to the respective disposed numbers of photo receivers PD which monotonically increase with the increase in the level, in comparison with the case where the photo receivers PD of levels 1 to 16 are disposed up to the constant disposed number of the photo receivers PD regardless of the increase in the level.

Next, display processing and recognition processing of the display device 1 are described. Firstly, descriptions are given of the display processing for displaying display an image supplied from the outside such as a host device.

The logic circuit 16 gives, to the signal line drive circuit 13, a display image supplied from the outside. In response to this, for a first horizontal scan period in one frame period, the signal line drive circuit 13 sets a voltage of a video signal being supplied to each of the signal lines S to a voltage depending on a gradation value of a position in the display image, the position corresponding to the signal line S, for example, in a horizontal direction, in the uppermost row.

In addition, for this horizontal scan period, the scan line drive circuit 12 drives the scan line G corresponding to the pixels 11a in an uppermost row. This causes the pixel transistors T1 connected to the scan line G to be conducting, and causes a video signal (a voltage depending on a corresponding gradation value) to be written in each pixel capacitance L connected to each pixel transistor T1. In other words, the pixel capacitance L is charged according to the gradation value. Thus, an amount of transmitted light in each pixel capacitance L becomes one depending on the gradation value, and the uppermost row in the pixel unit 11 displays the uppermost row of the display image.

For the sequential horizontal scan period, while maintaining the display in the uppermost row, the second row in the pixel unit 11 displays the second row of the display image, in the same manner. Then, the same processing is performed in sequence for the following horizontal scan periods. For the last horizontal scan period in this frame period, the lowermost row in the pixel unit 11 displays the lowermost row of the display image. Consequently, the entire display image is displayed in one frame period. In addition, the display image is continuously displayed by performing the display for one frame period in the manner same as is described for the following frame periods.

Subsequently, descriptions are given of the recognition processing of recognizing the contact of a target recognition object such as a finger.

The logic circuit 16 gives, to the signal line drive circuit 13, a display image, which is used for recognition, supplied from the outside such as a host device. Thereby, the display device 1 performs the above-described display processing, and displays the display image used for recognition. In addition, the display device 1 performs the following processing in a blank period between frame periods.

First, for the first period in the blank period, the control circuit 14 performs a control for causing a voltage of each of the signal lines S to be a predetermined pre-charge voltage. In addition, the control circuit 14 performs a control for causing he reset line RST and the control line CNT of the pixels 11a in the uppermost row to have, for example, high voltages. In each of the pixels lea in the uppermost row, the sensor capacitance C2 is charged up to the predetermined pre-charge voltage. After precharging, the control circuit 14 performs a control for causing the reset line RST and the control line CNT to be low voltages, for example. Subsequently, when the photo receivers PD receive light such as environmental light or backlight, the sensor capacitances C2 corresponding to the respective photo receivers PD start discharging.

Next, when an exposure time corresponding to exposure time data set by the logic circuit 16 elapses, the control circuit 14 performs a control for causing the control line CNT to have, for example, a high voltage, and causes the buffers BF to operate by making the control transistors T3 turned on. Thus, the buffer BF temporarily holds the voltage of the corresponding sensor capacitance C2 at that moment. Then, the buffer BF outputs the held voltage to the corresponding detection line DCT as a sensor output signal. In response to this, the detection circuit 15 converts the sensor output signal inputted from each of the detection lines DCT into a serial signal, and outputs the serial signal to the logic circuit 16, as an image pick-up signal.

For the subsequent period, the same processing is performed, so that the detection circuit 15 outputs serial signals of the second row to the logic circuit 16. The same processing is performed in sequence for the following periods. For the last period, the detection circuit 15 outputs serial signals of a lowermost row to the logic circuit 16. In this way, the logic circuit 16 captures each of serial signals, i.e. a two-gradation image in a blank period. In addition, by performing the same processing thereafter, the logic circuit 16 successively captures two-gradation images.

As described above, in the display device 1 of the first embodiment of the present invention, the photo receivers PD are disposed up to the disposed number of photo receivers PD, which monotonically increases as the size thereof increases. This makes it possible to enhance the entire light detection sensitivity while curbing a decrease in the aperture ratio. This results in the suppression in a decrease in the recognition performance due to a decrease in the luminance level of detected light.

Furthermore, the number of photo receivers PD monotonically increases, as a linear function, an exponential function or a logarithmic function, according to the size of the photo receiver PD. This does not require a function having a complicated waveform to be used, and allows the number of photo receivers PD to monotonically increase by using the simple calculation processing.

### Second Embodiment

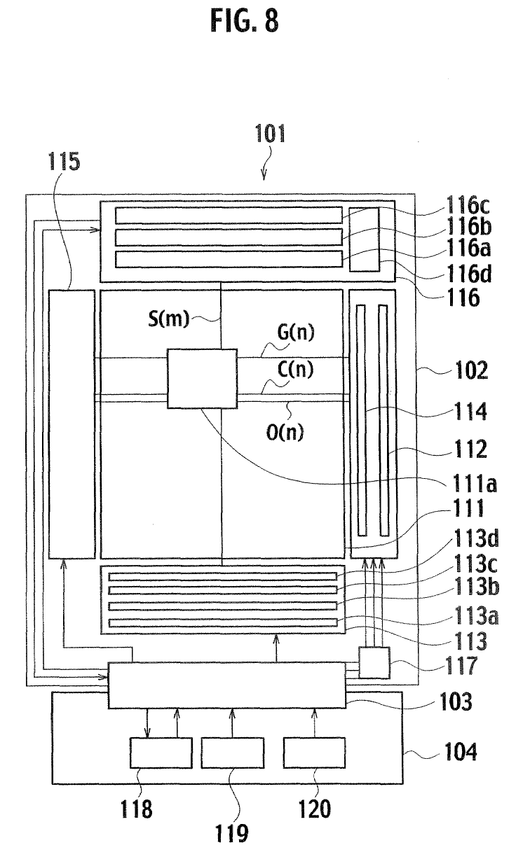

A second embodiment is described below by referring to FIGS. 8 to 15.

### <Description of Entire Constitution of Display Device>

As shown in FIG. 8, a display device 101 of the second embodiment of the present invention includes an array substrate 102 formed of a transparent substrate such as a glass substrate, and an external substrate 104 connected to the array substrate 102 with a flexible substrate 103 interposed therebetween.

The array substrate 102 is provided with a display area unit 111, a scan line drive circuit 112, a signal line drive circuit 113, a reset control line drive circuit 114, an output control line drive circuit 115, a sensor output circuit 116, an interface circuit 117 and the like. The display area unit 111 displays an image. The scan line drive circuit 112 outputs scan signals GATE to scan lines G(n: a positive integer). The signal line drive circuit 113 outputs video signals to signal lines S(m: a positive integer). The reset control line drive circuit 114 outputs reset control signals CRT to reset control lines C(n: a positive integer). The output control line drive circuit 115 outputs output control signals OPT to output control lines O(n: a positive integer). The sensor output circuit 116 outputs sensor output data to the external substrate 104. The interface circuit 117 serves for an interface with the external substrate 104.

The flexible substrate 103 is provided with a plurality of wirings that electrically connect the array substrate 102 with the external substrate 104.

The external substrate 104 is provided with a control circuit 118, a common circuit 119, a power source circuit 120 and the like. The control circuit 118 outputs various kinds of signals including control signals to the array substrate 102. The common circuit 119 supplies a common voltage to the array substrate 102. The power source circuit 120 supplies various kinds of voltages to the array substrate 102. As the external substrate 104, for example, a print substrate or the like is used.

The display area unit 111 is a display area in which a plurality of pixel areas having a plurality of pixels are disposed, and is located in the center portion of the array substrate 102. Then, the scan line drive circuit 112, the signal line drive circuit 113, the reset control line drive circuit 114, the output control line drive circuit 115, the sensor output circuit 116 and the interface circuit 117 are disposed in an area other than the display area provided with the display area unit 111 on the array substrate 102, i.e., in a frame area.

In addition, the display area unit 111 includes a plurality of scan lines G(n), a plurality of signal lines S(m), a plurality of reset control lines C(n), a plurality of output control lines O(n), a plurality of sensor integrated pixels 11a and the like. The scan lines G(n) and the signal lines S(m) are provided so that they would intersect one another. The reset control lines C(n) and the output control lines O(n) are provided so that they would be in parallel to the respective scan lines G(n). The sensor integrated pixels 111a are respectively connected to the scan lines G(n), the signal lines S(m), the reset control lines C(n) and the output control lines O(n). The display area unit 111 has a display function for displaying an image based on video data, and an image pick-up function (a light input function) for picking up an image of a target recognition object such as a finger approaching the display area unit 111.

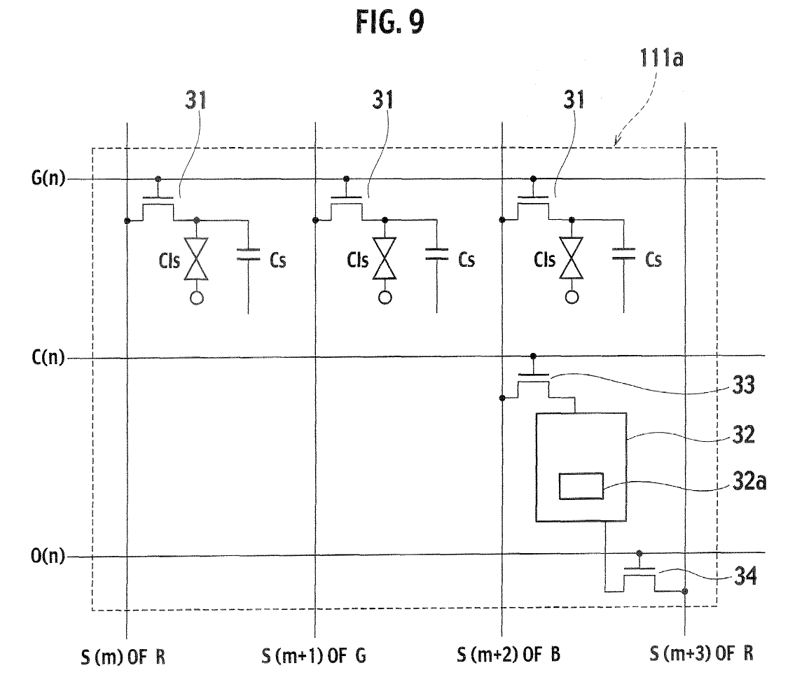

As shown in FIG. 9, the sensor integrated pixel 111a is provided with three pixel transistors 31, a control transistor 33, a control transistor 34 and one light sensor 32. The three pixel transistors 31 are disposed at respective intersections where three signal lines S(m) to S(m+2) for red (R), green (G) and blue (B) intersect the scan line G(n). The control transistor 33 is disposed at an intersection where the reset control line C(n) intersects the signal line S(m+2) for B. The control transistor 34 is disposed at an intersection where the output control line O(n) intersects the signal line S(m+3) for R. The light sensor 32 is connected to the control transistor 33 and the control transistor 34. In addition, an unillustrated buffer circuit is provided between the control transistor 34 and the signal line S(m+3) for R. As the pixel transistor 31, the control transistor 33 and the control transistor 34, for example, MOS thin-film transistors or the like are used.

All the gate electrodes of the pixel transistors 31 are connected to the scan line G(n). The source electrodes thereof are connected respectively to the signal lines S(m) to S(m+2). Each of the drain electrodes thereof is connected to a pixel capacitance C1s and an auxiliary capacitances Cs. The pixel transistors 31, the pixel capacitances C1s, and the auxiliary capacitances Cs operate as the above-described display function for outputting an image based on video data.

In contrast, the light sensor 32 includes a photoelectric conversion element 32a that converts light into electric energy, a sensor capacitance (not illustrated), an amplifier circuit (not illustrated) consisting of a source follower circuit and the like. The light sensor 32 is connected to the drain electrodes of the control transistor 33 and the control transistor 34. The source electrode of the control transistor 33 is connected to the signal line S(m+2) for B, and the gate electrode thereof is connected to the reset control line C(n). The source electrode of the control transistor 34 is connected to the signal line S(m+3) for R with a buffer circuit interposed therebetween, and the gate electrode thereof is connected to the output control line O(n). An earth electrode of the light sensor 32 is connected to a signal line GND (not illustrated). The light sensor 32, the control transistor 33 and the control transistor 34 operate as the above-mentioned image pick-up function (the light input function) for capturing an image of a target recognition object. As the photoelectric conversion element 32a, for example, a photodiode or the like is used.

Incidentally, the display device 101 is not limited to a liquid crystal display device using a liquid crystal layer. The display device 101 may be formed of, for example, luminous elements, as an organic EL display.

### <Descriptions of Each Circuit Constituting Display Device>

Each of the circuits constituting a display device is described by referring to FIGS. 8 to 10.

The scan line drive circuit 112 is a circuit which sequentially outputs scan signals GATE to the respective scan lines G(n) for every one horizontal period, i.e. for every video writing period in one horizontal period, and causes each of the scan lines G(n) to be driven. Here, the scan signal GATE is a signal for driving (turning on) each of the pixel transistors 31.

The signal line drive circuit 113 is a circuit which outputs video signals to the respective signal lines S(m) in synchronization with the scan signals GATE, and causes each of the signal lines S(m) to be driven. Here, the video signal is a signal for giving voltages to the pixel capacitance C1s and the auxiliary capacitance Cs on the basis of video data. Detail descriptions of the configuration and operations of the signal line drive circuit 113 are described later.

The reset control line drive circuit 114 includes a shift resister (not illustrated) and a buffer circuit (not illustrated). This reset control line drive circuit 114 outputs reset control signals CRT to the respective reset control lines C(n) by using the buffer circuit according to shift pulses sequentially propagating through the shift resistor, and causes the reset control lines C(n) to be driven in sequence. Here, the reset control signal CRT is a signal for driving (turning on) the control transistor 33.

The output control line drive circuit 115 includes a shift resistor (not illustrated) and a buffer circuit (not illustrated). This output line drive circuit 115 outputs output control signals OPT to the respective output control lines O(n) by using the buffer circuit, according to shift pulses sequentially propagating through the shift resistor, and thus causes the output control lines O(n) to be driven in sequence. Here, the output control signal OPT is a signal for driving (turning on) the control transistor 34.

The sensor output circuit 116 includes an AD conversion circuit 116a, a shift resistor 116b, an output buffer 116c, and a synchronizing signal generation circuit 116d. The sensor output circuit 116 converts sensor output signals into digital signals by using the AD conversion circuit 116a. The sensor output signals are transmitted to the shift resistor 116b from the light sensor 32 through the control transistor 34. In addition, the sensor output circuit 116 stores the digital signal obtained by the conversion in the output buffer 116c, and then outputs the stored digital signals as sensor output data to the control circuit 118 one bit by one bit in synchronization with clock signals outputted from the synchronizing signal generation circuit 116d. The output buffer 116c functions for performing an operation of adjusting the amplitude of the digital signals outputted from the shift resistor 116b to the level depending on an interface of the control circuit 118 or the like, and for performing an operation of increasing the amplitude thereof to the level depending on a drive load until the digital signal reaches an external circuit such as the control circuit 118.

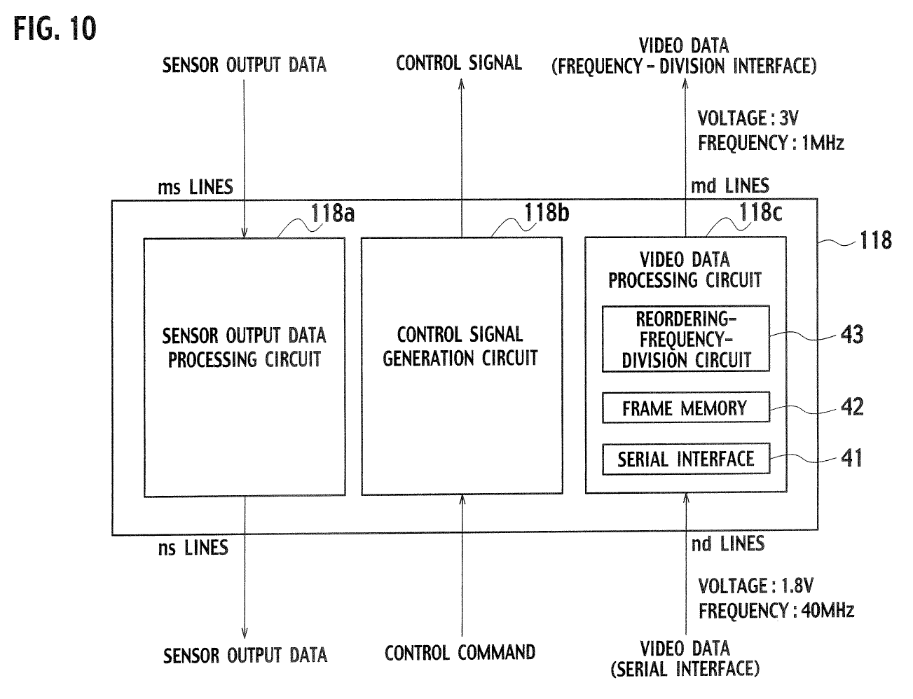

As shown in FIG. 10, the control circuit 118 includes a sensor output data processing circuit 118a, a control signal generation circuit 118b, a video data processing circuit 118c, and the like. The sensor output data processing circuit 118a receives sensor output data sent from the sensor output circuit 116, performs predetermined image processing on the sensor output data, and sends the data thus processed to a host device (not illustrated). The control signal generation circuit 118b generates a control signal in response to a control command sent from the host device, and sends the control signal thus generated to the signal line drive circuit 113 and the like. The vide data processing circuit 118c includes a serial interface 41 which is an interface with the host device; a frame memory 42 which stores video data sent from the host device through the serial interface 41; a reordering-frequency-division circuit 43 which reorders the vide data stored in the frame memory 42, and divides the frequency of the video data; and the like. This video data processing circuit 118c receives digital video data sent from the host device through the serial interface 41, and stores the received video data in the frame memory 42. The video data are reordered and the frequencies thereof are divided by the reordering-frequency-division circuit 43. Then, the video data processing circuit 118c sends the video data to the signal line drive circuit 113. Thus, the digital video data sent from the host device are reordered according to a circuit structure of the signal line drive circuit 113 of the array substrate 102, and then are sent thereto.

Since the control circuit 118 includes a high speed logic circuit, a memory circuit and the like, it is advantageous in cost and size that the control circuit 118 is formed of an integral LSI (integrated circuit) rather than formed of separated LSIs. In addition, while the interface with the host device is a serial interface with low voltage (1.8 volts) and high frequency (40 MHz) an interface with the array substrate 102 on which the signal line drive circuit 113 and the like are disposed is a frequency-division interface with high voltage (3 volts) and low frequency (1 MHz). This is because the speed of operations of circuits formed on an insulating substrate such as the array substrate 102 and the like is slow compared with that of circuits formed on a silicon substrate such as the external substrate 104.

### <Description of Detail Constitution and Operations of Signal Line Drive Circuit>

Here, returning to FIG. 8, a detail constitution and operations of the signal line drive circuit 113 are described.

The signal line drive circuit 113 includes a data latch circuit 113a, a DA conversion circuit 113b, a precharge circuit 113c, a selection circuit 113d and the like. The data latch circuit 113a stores video data sent from the control circuit 118. The DA conversion circuit 113b converts the digital video data stored in the data latch circuit 113a into analog signals, and then outputs the video data as video signals. The precharge circuit 113c precharges each of the signal lines S(m) to a predetermined electric potential. The selection circuit 113d selectively connects the signal lines S(m) to outputs and the like from the DA conversion circuit 113b and the precharge circuit 113c. Moreover, the precharge circuit 113c supplies precharge voltages V_{prc}, which are sent from the control circuit 118, respectively to the signal lines S(m). The precharge voltages V_{prc} is supplied from the power source circuit 120, and then adjusted by the control circuit 118, according to a precharge control signal PRCR for R, a precharge control signal PRCG for G, and a precharge control signal PRCB for B.

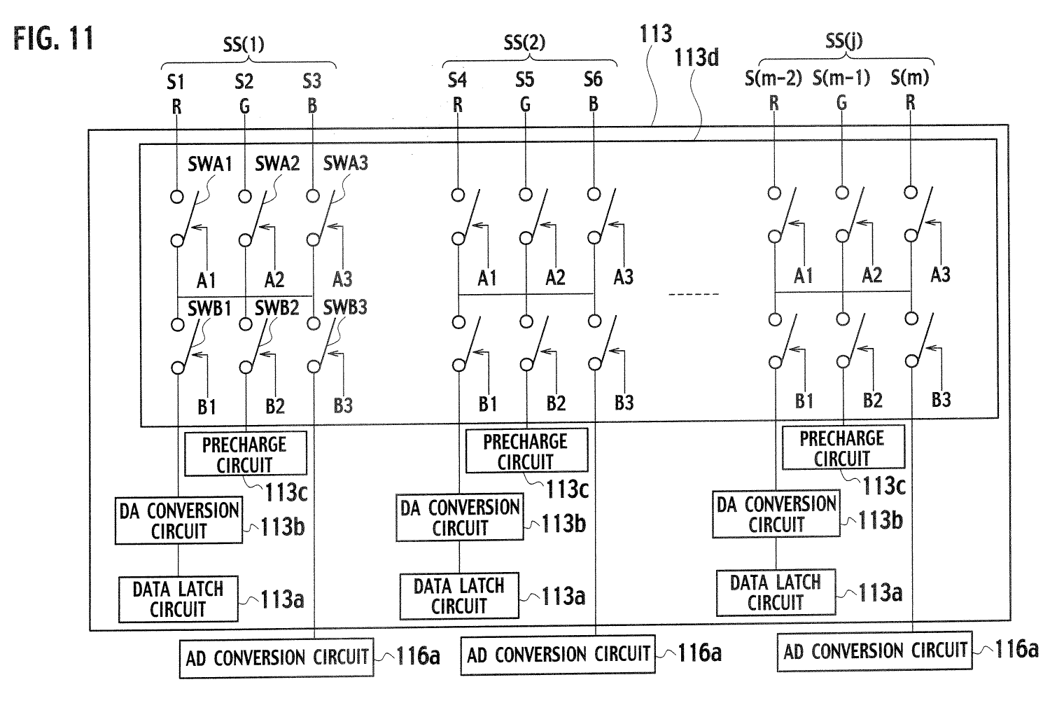

As shown in FIG. 11, the signal lines S(m) are divided into a plurality of signal line groups SS(j: a positive integer). To be more precise, the signal lines S(m) are divided into the plurality of signal line groups SS(j) each including, for example, three signal lines S(m) to S(m+2) used respectively for RGB. Thus, one signal line group SS (j) is a set of the three signal lines S(m) to S(m+1).

A plurality of the data latch circuits 13a, a plurality of the DA conversion circuits 13b, and a plurality of the precharge circuits 13c are provided on the array substrate 102. Each set of the circuits 13a to 13c corresponds to one of the signal line groups SS (j). In addition, each of the plurality of the data latch circuits 13a is connected to corresponding one of the DA conversion circuits 13b.

As shown in FIG. 11, the selection circuit 113d has a configuration in which three switching elements SWA1 to SWA3 are correspondingly connected to the respective three signal lines S(m) to S(m+2) forming one signal line group SS(j), and in which a plurality of switching elements SWB1 to SWB3 are correspondingly connected to the respective switching elements SWA1 to SWA3.

Drive controls, i.e., on-off controls (open-close controls), of the switching elements SWA1 to SWA3 are performed by using the respective switch control signals A1 to A3 sent from the control circuit 118. Drive controls, i.e., on-off controls (open-close controls), of the switching elements SWB1 to SWB3 are performed by using the respective switch control signals B1 to B3 sent from the control circuit 118.

The selection circuit 113d selects any one of a connection of the DA conversion circuits 13b with the respective signal line group SS(j); a connection of the precharge circuits 13c with the respective signal line group SS(j); and a connection of the AD conversion circuits 116a with the respective signal line group SS(j).

Here, in a case where the signal lines S1, S4, . . . , S(m−2) for R are connected to the respective DA conversion circuits 13b, the switch control signals A1 and B1 are set active. In response to this, each of the switching elements SWA1 and each of the switching elements SWB1 become in ON states, and thus the signal lines S1, S4, S(m−2) for R are connected to the respective DA conversion circuits 13b. This causes outputs from the respective DA circuit 113b to be written into the signal lines S1, S4, . . . , S(m−2) for R. In the same manner, in a case where the signal lines S2, S5, . . . , S(m−1) for G are connected to the respective DA conversion circuits 13b, the switch control signals A2 and B1 are set active. Moreover, in a case where the signal lines S3, S6, . . . , S(m) for B are connected to the respective DA conversion circuits 13b, the switch control signals A3 and B1 are set active.

In this manner, digital video data stored in each of the data latch circuits 13a is converted into an analog signal by each of the DA conversion circuits 13b, and then is written into each of the signal lines S(m) as a video signal.

In a case where the signal lines S3, S6, . . . , S(m) for B are connected to the respective precharge circuits 13c, the switch control signals A3 and B2 are set active. In response to this, each of the switching elements SWA3 and each of the switching elements SWB2 becomes in the ON states, and thus the signal lines S3, S6, . . . , S(m) for B are connected to the precharge circuits 13c.

This causes the precharge voltages V_{prc} to be written into the respective signal lines S3, S6, . . . , S(m) for B. The precharge voltages V_{prc} thus written are supplied to the respective light sensors 32 in response to driving of the control transistor 33 by using the reset control signal CRT.

In a case where the signal lines S1, S4, . . . , S(m−2) for R are connected to the respective precharge circuits 13c, needless to say, it is also possible to set the switch control signals A1 and B2 active. In response to this, each of the switching elements SWA1 and each of the switching elements SWB2 become in the ON states. The signal lines S1, S4, S(m−2) for R are connected to the respective precharge circuits 13c. In the same way, in a case where the signal lines S2, S5, . . . , S(m−1) for Gare connected to the respective precharge circuits 13c, it is also possible to set the switch control signals A2 and B2 active. In response to this, each of the switching elements SWA2 and each of the switching elements SWB2 become in the ON state. The signal lines S2, S5, . . . , S(m−1) for G are connected to the respective precharge circuits 13c.

In a case where the signal lines S1, S4, . . . , S(m−2) for R are connected to the respective AD conversion circuits 116a, the switch control signals A1 and B3 are set active. In response to this, each of the switching elements SWA1 and each of the switching elements SWB3 become in the ON states. Thus, the signal lines S1, S4, . . . , S(m−2) used fro R are connected to the respective AD conversion circuits 116.

This causes sensor output signals outputted from the respective light sensors 32 to be sent to the respective AD conversion circuits 116a in response to driving of the control transistor 34 by using output control signal OPT.

In a case where the signal lines S2, S5, . . . , S(m−1) for G are connected to the respective AD conversion 116a, needless to say, it is also possible to set the switch control signals A2 and B3 active. In response to the above, each of the switching elements SWA2 and each of the switching elements SWB3 become in the ON states, and the signal lines S2, S5, . . . , S(m−1) for G are connected to the respective AD conversion circuits 116a. In the same way, in a case where the signal lines S3, S6, S(m) for B are connected to the respective AD conversion circuits 116a, it is also possible to set the switch control signals A3 and B3 active. In response to this, each of the switching elements SWA3 and each of the switching elements SWB3 become in the ON states, and the signal lines S3, S6, . . . , S(m) for B are connected to the respective AD conversion circuits 116a.

### <Description on Light Detection Sensitivity of Light Sensor>

Descriptions are given below of the light detection sensitivity of the light sensor 32 described using FIG. 9.

The light detection sensitivity of the light sensor 32 is proportional to the size of the light sensor 32, especially the width thereof. The processing accuracy in manufacturing processes limits the minimum width of the light sensor 32, and the size of the display area unit 111 limits the maximum width thereof. Accordingly, if the width of the light sensor 32 is excessively enlarged in order to increase the light detection sensitivity, the aperture ratio drastically decreases. For this reason, it is necessary to determine the width of the light sensor 32 in consideration of a trade-off with the aperture ratio. Incidentally, the aperture ratio indicates a ratio of the area of a portion, extruding wirings, transistors and the like in one pixel, through which light passes, to the area of the entire pixel. The higher the aperture ratio is, the higher the light transmittance is.

For example, it is possible to increase the light detection sensitivity of the display device 101 up to the highest level, when the width of the light sensor 32 is made as large as possible, a plurality of pixels having the light sensors 32 with the same largest width are disposed in one pixel area, and a plurality of the pixel areas are disposed in a display area unit 111, which is a display area. In this case, the above example is advantageous in a dark place. In a bright place, however, the excessively high light detection sensitivity results in an occurrence of the saturation of a picked-up image (for example, the picked-up image becomes entirely white) since the amount of electricity flown according to the amount of detected light becomes too large. Furthermore, the non-uniformity in the properties of the respective light sensors 32 has a direct effect on the non-uniformity of a picked-up image. This facilitates an occurrence of the unevenness of a picked-up image.

For this reason, a plurality of pixels including the light sensors 32 having different widths are disposed in a pixel area of the display device 101. Here, the widths of the light sensors 32 increase in an arithmetical series from small to large. This configuration makes it possible to accomplish the function for picking up a target recognition object in a wide range of a dark place to a bright place, by causing the light sensors 32 having the different widths in the pixel area to be saturated in sequence. To be more precise, for example, nine levels of widths increasing in an arithmetical series (hereinafter, simply referred to as nine arithmetical levels) are employed, that is, 4 μm, 8 μm, 12 μm, 16 μm, 20 μm, 24 μm, 28 μm, 32 μm and 36 μm. Then, the light sensors 32 respectively of the above nine arithmetical levels are disposed in a 3×3 pixel area, and a plurality of such pixel areas are disposed in the display area unit 111, which is a display area.

With this configuration, it is possible to calibrate the light detection sensitivity by sizing the widths of the light sensors 32.

Moreover, in addition to the above-mentioned plural light sensors 32 of nine arithmetical levels, it is possible to further dispose, in the pixel area, plural light sensors 32 having the same width as the maximum width of the plural light sensors 32 of nine arithmetical levels.

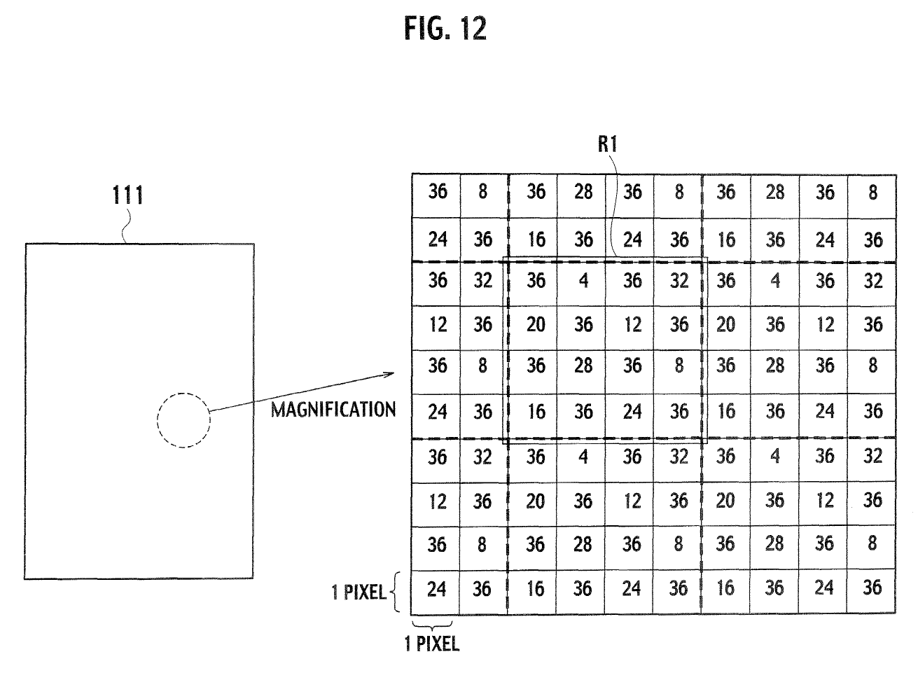

FIG. 12 is a plan view showing a configuration, in which, a plurality of light sensors 32 of nine arithmetical levels, and a plurality of light sensors 32 having the same width as the maximum width of the plural light sensors 32 of nine arithmetical levels are disposed in one pixel area R1, and in which a plurality of such pixel areas R1 are disposed in a display area unit 111 that is a display area. Each of numerals shown in FIG. 12 represents the width (unit: μm) of the light sensor 32 in each of the respective pixels. The display device 101 is configured by repetitively arranging, in the display area unit 111, 4×4 pixel areas R1 in which a plurality of light sensors 32 having nine different widths are disposed. In this 4×4 pixel area R1, seven more light sensors 32 having the same width as the maximum width 36 μm of the light sensors 32 of nine arithmetical levels are further disposed in addition to the above-described light sensors 32 of nine arithmetical levels having the widths 4 μm to 36 μm. Accordingly, one pixel area R1 in FIG. 12 has a configuration in which half of the 16 light sensors 32 in total disposed in the 4×4 pixel area R1 are the light sensors having the maximum width (36 μm).

In a case of comparing the two light detection sensitivities of the following display area units 111: one has a configuration in which only light sensors 32 of the equal level of the width of 36 μm are disposed in a 3×3 pixel area; and the other one has a configuration in which light sensors 32 of nine arithmetical levels with the widths of 4 μm to 36 μm are disposed in a 3×3 pixel area, the light detection sensitivity of the latter device is decreased to about ⅝ of the light detection sensitivity of the former device. As described using FIG. 12, however, the light detection sensitivity can be increased without decreasing the aperture ratio by further adding the light sensors 32 having the same widths as the maximum width 36 μm of the light sensors 32 of nine arithmetical levels.

Accordingly, the display device 11 shown in FIG. 12 is capable of achieving a calibration for preventing a black blur or a white blur of a picked-up image from occurring by using the plurality of light sensors 32 of nine arithmetical levels, and of increasing the light detection sensitivity as a whole by further adding the plurality of light sensors 32 having the width of 36 μm that is the maximum width of the plurality of light sensors 32 of nine arithmetical levels.

Incidentally, the plurality of light sensors 32 of arithmetical levels may be replaced by those of levels of widths increasing in a geometrical series. In addition, although description has been given by using the additionally-disposed light sensors 32 having the same width as the maximum width of the light sensors 32 of nine arithmetical levels, the width can be larger than the maximum one. This configuration can further increase the light detection sensitivity.

Moreover, in FIG. 12, by taking a pixel area R1 provided with 4×4 pixels as an example, the descriptions have been given of the case where the number of the light sensors 32 added to the 3×3 pixel area is seven. The number of the light sensors 32 to be added, however, is not limited to seven. Note that the number of light sensors 32 to be added is preferably at least ⅓ of the number of the light sensors 32 of nine arithmetical levels This is because a too small number of additional light sensors 32 cannot enhance the properties of the light detection sensitivity.

Furthermore, it is preferable that these additional light sensors 32 be disposed at random in one pixel area. This configuration can check an effect of the non-uniformity of sensor properties occurring in manufacturing processes or the like, and thus prevent the periodical unevenness that would otherwise occur at the time of picking up images.

Still furthermore, while one light sensor 32 is disposed in one pixel in FIGS. 9 and 12, a disposing manner is not limited to this. In a case of a display device with a large number of pixels and a high pixel density, the disposition density of the light sensors 32 may be reduced to, for example, one for four pixels. In contrast, it is naturally possible to increase the disposition density by providing the light sensors 32 corresponding to the respective sub-pixels of RGB forming one pixel.

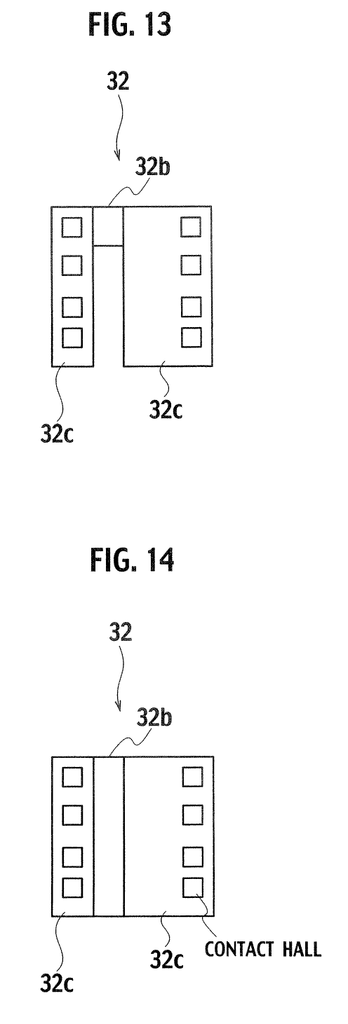

In addition, since it is not desired that light transmittance be different between pixels or sub-pixels where light sensors 32 are disposed, it is preferable that a difference in light transmittance be minimized by covering the light sensors 32 with metallic wirings which supply electric potential to the light sensors 32. With this configuration, a light-blocking layer formed of the metal wirings plays roles with respect to light incidence from the array substrate 102, that is, a role in blocking light from a backlight, and a role in leading part of light entered from the array substrate 102 into the light sensors 32 by reflecting the part thereof. For example, as shown in FIGS. 13 and 14, the light transmittance is adjusted by changing the width of a polysilicon (p-Si) layer 32b or a metal wiring layer formed 32c of A1 so that the light transmittance of all the pixels or all the sub-pixels would be substantially the same. Incidentally, the width of a light sensor 32 (a p-Si layer 32b) shown in FIG. 14 is larger than that of a light sensor 32 (a p-Si layer 32b) shown in FIG. 13.

Hence, making light transmittance of all the pixels or all the sub-pixels substantially the same can prevent an occurrence of the degradation of display quality, such as luminance non-uniformity, of the display device 101.

Moreover, in a case of where a light sensor 32 is disposed in any one of sub-pixels of RGB, the transmittance of the sub-pixel where the light sensor 32 is disposed is decreased. Accordingly, in order to check degradation of white balance when displaying white, it is desirable to make the transmittance of all the sub-pixels substantially the same by adjusting the width of the sub-pixel where the light sensor 32 is disposed and the widths of the other sub-pixels. Here, a circuit for driving the light sensor 32 can be disposed in a sub-pixel where the light sensor 32 is not disposed. Note that a degree of gradation difference which allows a target recognition object such as a finger to be detected depends on an algorithm of a detection determination program stored in the control circuit 118.

### <Description of Operations of Sensor Integrated Pixels>

Operations of the sensor integrated pixel 111a are described by referring to FIGS. 9, 11 and 15.

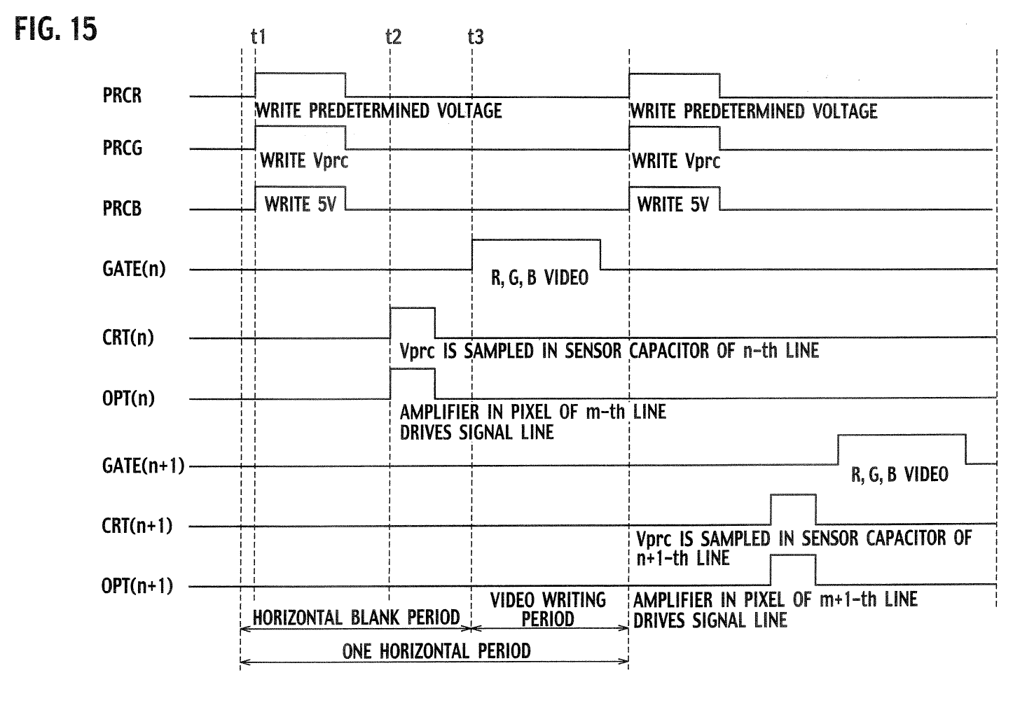

FIG. 15 is a timing chart of processing operations in the sensor integrated pixel 111a. FIG. 15 shows relationships: between a scan signal GATE(n) and the pixel transistor 31; between a reset control signal CRT(n) and the light sensor 32; between an output control signal OPT(n) and the light sensor 32; and between recharge control signals PRCR, PRCG, PRCB and the precharge circuit 113c. Here, one horizontal period consists of a horizontal blanking period and a video writing period.

Once the precharge control signal PRCB rises to a high level with the control circuit 118 at a time t1 in one horizontal period, the switch control signals A3 and B3 become active at a predetermined timing, and each of the switching elements SWA3 and each of the switching elements SWB2 becomes in the ON state. This causes the signal lines, S3, S6, . . . , S(m) for B to be connected to the respective precharge circuits 13c, and precharge voltages V_{prc} (for example, 5 volts) for the light sensors 32 are written into the signal lines S3, S6, . . . , S(m) for B from the precharge circuits 13c.

Needless to say, it is also possible to cause the precharge control signals PRCR to rise to a high level with the control circuit 118 at the same time. This causes the switch control signals A1 and B2 to become active at a predetermined timing, and each of the switching elements SWA1 and each of the switching elements SWB2 to become in the ON state. This causes the signal lines S1, S4, . . . , S(m−2) for R to be connected to the respective precharge circuits 13c, and precharge voltages V_{prc} for the light sensors 32 to be written into the signal lines S1, S4, . . . , S(m−2) for R from the precharge circuits 13c.

As a matter of course, it is further possible to cause the precharge control signals PRCG to rise to a high level with the control circuit 118 at the same time. This causes the switch control signals A2 and B2 to become active at a predetermined timing, and each of the switching elements SWA2 and each of the switching elements SWB2 to become in the ON state. This causes the signal lines S2, S5, . . . , S(m−1) for G to be connected to the respective precharge circuits 13c, and precharge voltages V_{prc} for the light sensors 32 to be written into the signal lines S2, S5, . . . , S(m−1) for G from the precharge circuits 13c In this embodiment, as shown in FIG. 9, the light sensor 32 is connected to a signal line for B with the control transistor 33 interposed therebetween. Accordingly, it is not necessary to cause the precharge control signals PRCR and PRCG to rise to a high level. However, in consideration of a case or the like where another light sensor 32 is connected to a signal line for R or to a signal line for G, it is possible to cause the precharge control signals PRCR and PRCG to rise to the high level as described above.

Next, when the reset control signal CRT (n) rises to a high level with the reset control line drive circuit 114 at a time t2 in the one horizontal period, the control transistors 33 connected to the reset control line C(n) become in the ON state. Then, sensor capacitances each included n the light sensor 32 of the sensor integrated pixel 111a are precharged with the precharge voltages V_{prc} written in the signals lines S3, S6, . . . , S(m) for B.

In addition, when the output control line drive circuit 115 causes the output control signal OPT (n) to rise to a high level, the control transistors 34 connected to the output control line O(n) become in the ON state. As a result, the light sensors 32 of the sensor integrated pixels 111a are electrically connected to the signal lines S(m) (the signal line is equivalent to S(m+3) for R shown in FIG. 9). At this time, when the electric potential of the sensor capacitance is high, an electric potential outputted to the signal line S(m) hardly changes from 5 volts. In this manner, sensor output signals are outputted to the signal lines S(m) from the light sensors 32.

Subsequently, when the scan line drive circuit 112 causes the scan line signal GATE (n) to rise to a high level at a time t3 in the one horizontal period, the signal line drive circuit 113 causes the writing of video signals into the respective signal lines S(m) to start. At this time, the switch control signals A1 and B1 become active, and each of the switching elements SWA1 and each of the switching elements SWB1 become in the ON state. This causes the signal lines S1, S4, . . . ., S(m−2) for R to be connected to the respective DA conversion circuits 13b. Then, analog video signals outputted from the respective DA conversion circuits 13b are written into the signal lines S1, S4, . . . , S(m−2) for R. In the same way, analog video signals outputted from the respective DA conversion circuits 13b are also written into the signal lines S2, S5, . . . , S(m−1) for G and the signal lines S3, S6, S(m) for B. Thereafter, the writing of video signals is completed and, upon completion of the writing, the one horizontal period ends. One horizontal period is set to a very short period, e.g., 50 μs.

In this manner, the precharging of the light sensors 32, the processing for outputting from the light sensors 32, and the processing for writing video signals are performed in sequence, thus achieving the above-mentioned picking-up function (the light input function) for picking up an image of an external target recognition object, and the above-mentioned display function for displaying an image based on video data. Detail processing of the picking-up function (the light input function) and the display function are described later.

The above descriptions have been given of the drive method in which the signal lines S(m) for writing video signals video writing are also used as the signal lines used when sensor output signals are outputted from the light sensors 32 to the sensor output circuit 116. It is possible, however, to use dedicated lines for precharging the light sensor 32 and for reading out sensor signals.

Here, a detection method of a target recognition object is briefly described. As an “exposure time,” defined is a period starting from a time when a precharge voltage V_{prc} is applied with the control transistor 33 be in the ON state, ending at a time when a sensor output signal is outputted from the light sensor 32 to the signal line S(m) with the control transistor 34 be in the ON state. An output of the light sensor 32 changes according to the magnitude of a precharge voltage V_{prc}, the intensity of light to which the light sensor 32 is exposed, and the exposure time thereof. In other words, a target recognition object, e.g. the shadow of a finger or the like, approaching the display area unit 111 can be detected by detecting the magnitude of a precharge voltage V_{prc}, the length of the exposure time, the intensity of light to which the light sensor 32 is exposed Here, the intensity of light is detected by using an amount of leaking light of the light sensor 32.

It is desirable that the exposure time and the precharge voltage V_{prc} be adjusted so that a black blur and a white blur in a picked-up image to be captured would not occur. To be more precise, when the intensity of the outside light is high, it is necessary to shorten the exposure time in a case where a constant precharge voltage V_{prc} is applied. The reason for this is that the higher the intensity of the outside light is, the larger the amount of leaking light of the light sensor 32 is, and that a discharge amount of electric charge is proportional to the length of the exposure time. By contrast, when the intensity of the outside light is low, it is better to set the exposure time to be longer. In a case where the discharge amount is large even after shortening the exposure time, the precharge voltage V_{prc} should be set to be a high voltage.

In other words, the light detection sensitivity of the display device 101 can be more finely adjusted by suitably controlling the exposure time and the precharge voltage V_{prc} with the control circuit 118. Incidentally, the exposure time and the precharge voltage V_{prc} can be separately controlled.

The method of recognizing a recognition object is not limited to the one in which a target recognition object such as a finger is recognized by picking up the shadow thereof made with the outside light. For example, a target recognition object such as a finger may be recognized by picking up backlight reflected from the target recognition object. This method is effective in a case where the illumination intensity of the outside light is low.

The illumination intensity of backlight reflected from a target recognition object such as a finger is lower than that of the outside light. For this reason, reflected backlight cannot securely saturate all of the plural light sensors 32 which are disposed on a portion a finger approaches, and which have different light detection sensitivities. Consequently, a presence of the recognition object cannot be securely recognized. In addition, the backlight itself is suppressed in some cases. Accordingly, the sensor sensitivity of the display device 101 may be increased as a whole by replacing at least a part of data (sensor signal values), which are captured from a plurality of light sensors 32 having the arithmetically or geometrically different widths, with data (sensor signal values), which are captured from a plurality of light sensors 32 having the widths greater than or equal to the maximum width of the arithmetically or geometrically different widths. For example, the sensor output data processing circuit 118a or the host device is caused to perform an arithmetical operation for image processing, in which data (sensor signal values) captured from a plurality of light sensors 32 having the arithmetically or geometrically different widths are replaced with a mean value of data (sensor signal values) captured from a plurality of light sensors 32 having the widths greater than or equal to the maximum width of the arithmetically or geometrically different widths. An object approaching the display device 101 can be more securely recognized with this replacement, even in a case where the intensity of light reflected from a recognition object is low. This is because data captured from light sensors 32 with high light detection sensitivity are used instead of data captured from light sensors 32 with low light detection sensitivity.

### <Description of Display Processing>

The control circuit 118 gives, to the signal line drive circuit 113, video data supplied from the host device. In response to this, in the first one horizontal period, the signal line drive circuit 113 sets a voltage of video data to be supplied to each of the signal lines S(m) to a voltage depending on the S/N sensitivity of a corresponding position in a horizontal direction in, for example, the uppermost row of a display image.

Moreover, in the above-described horizontal period, the scan line drive circuit 112 drives a scan line G(1) corresponding to the uppermost row. This causes the pixel transistors 31 connected to this scan line G(1) to conduct, and video signals (voltages depending on the corresponding S/N sensitivity) to be written into the pixel capacitances C1s connected to the pixel transistors 31. In other words, the pixel capacitances C1s are charged according to the S/N sensitivity. As a result, the light transmittance of the pixel capacitances C1s becomes the light transmittance depending on the S/N sensitivity, and the uppermost row of the display area unit 111 displays the uppermost row of the display image.

In the subsequent horizontal period, the second row of the display area unit 111 displays the second row of the video data by following the same processing, while displaying the uppermost row. Then, the same processing is performed in sequence for the following rows. In the last horizontal period in the frame period, the lowermost row of the display area unit 111 displays the lowermost row of the video data. In this way, the entire video data are displayed in one frame period. In addition, the above-mentioned displaying in one frame period is performed in each of the following frame periods, and thus the video data are continuously displayed.

### <Description of Picking-up Processing (a light input process)>

Once the control circuit 118 gives, to the signal line drive circuit 113, video data supplied from the outside such as a host device, the display device 101 performs the above-described display processing, and displays the video data on the display area unit 111. In addition to this, the display device 101 performs the following processing in a horizontal blanking period between a video writing period and another video writing period.

First, in the first horizontal blanking period, the control circuit 118 controls the voltages of the respective signal lines S(m) so that the voltages would be predetermined precharge voltages V_{prc}. Moreover, the control circuit 118 controls a reset control line C(1) and an output control line O(1) in the uppermost row so as to be at high levels. In each sensor integrated pixel 111a in the uppermost row, a sensor capacitance included in a light sensor 32 is charged up to a predetermined precharge voltage. After precharging, the control circuit 118 controls the reset control line C(1) and the output control line O(1) so as to be at low levels. When each photoelectric conversion element 32a is exposed to light such as environmental light or backlight, discharging of the sensor capacitance progresses.

Subsequently, when an exposure time depending on exposure time data set by the control circuit 118 elapses, the reset control line drive circuit 114 and the output control line drive circuit 115 control the output control line O(n) so as to be at a high level, thus causes the control transistors 34 to be in the ON state, and activates the buffer circuits connected between the control transistors 34 and the signal lines S(m) (equivalent to S(m+3) for R shown in FIG. 9) Thus, the buffer circuits temporarily hold the voltages of the sensor capacitances and, thereafter, output the voltages to the signal lines S(m) as sensor output signals. In response to this, the sensor output circuit 116 converts the sensor output signals inputted from the respective signal lines S(m) into serial signals, and then outputs the serial signals to the control circuit 118 as sensor output data.

In the subsequent horizontal blanking period, the sensor output circuit 116 outputs serial signals of the second row to the control circuit 118 by following the same processing as above. Then, the same processing is performed in sequence for the following periods. In the last horizontal blanking period, the sensor output circuit 116 outputs serial signals of the lowermost row to the control circuit 118. Thus, in the horizontal blanking period, the control circuit 118 captures serial signals, i.e., a two-gradation image. By successively performing such processing, the control circuit 118 successively captures the two-gradation image.

According to the second embodiment of the present invention, it is possible to adjust the light detection sensitivity of a pixel area (and a display area) by using a plurality of light sensors 32 having the widths that are arithmetically different from one another, as is the case with the widths of 4 μm to 36 μm of the nine arithmetical levels, or that are geometrically different from one another. It is further possible to increase the light detection sensitivity of a pixel area (and a display area) by using a plurality of light sensors 32 having the widths greater than or equal to the maximum width, such as 36 μm, of the arithmetically or geometrically different widths. Accordingly, the display device 101 is capable of obtaining information on light properly and securely regardless of whether the illumination intensity of the outside light is high or low.

According to the second embodiment of the present invention, it is possible to more surely enhance the light detection sensitivity of the pixel area in a way that the number of light sensors 32 having widths greater than or equal to the maximum width of the arithmetically or geometrically different widths is not less than one third of the number of light sensors 32 having the arithmetically or geometrically different widths.

In the second embodiment of the present invention, the plurality of light sensors 32 having the arithmetically or geometrically different widths and the plurality of light sensors 32 having widths greater than or equal to the maximum width of the arithmetically or geometrically different widths are disposed at random in each pixel area. With this configuration, it is possible to check an effect of non-uniformity of light sensor properties generated in manufacturing processing or the like, and thereby to prevent periodical unevenness from occurring at the time of capturing an image.

According to the second embodiment of the present invention, it is also possible to surely prevent a black blur or a white blur from being formed in a picked-up image by further including a control circuit which adjusts an exposure time and/or a precharge voltage of the light sensor 32 according to the illumination intensity of the outside light.

In the second embodiment of the present invention, the transmittances of a plurality of pixels are substantially equal to one another. This configuration can avoids an occurrence of the degradation of display quality, such as unevenness of luminance, which would occurs in a case where a plurality of light sensors 32 having different widths are disposed.

According to the second embodiment of the present invention, the degradation of white balance of the display device 101 can be prevented from occurring by making the transmittances of the respective sub-pixels of red, green and red substantially equal to one another.

In the second embodiment of the present invention, at least a part of sensor signal values from a plurality of light sensors 32 having the arithmetically or geometrically different widths is replaced with sensor signal values from a plurality of light sensors 32 having widths greater than or equal to the maximum width of the arithmetically or geometrically different widths. With this configuration, an object approaching the display device 101 can be more surely recognized even when the illumination intensity of the outside light is low.

### Other Embodiments

It is to be understood that the present invention is not limited to the above-described embodiments, and various changes may be made without departing from the spirit of the present invention.

For example, in the first embodiment, a target recognition object such as a finger is recognized by capturing a shadow of the recognition object, which is made with environmental light. A method of recognizing a recognition object, however, is not limited to this. For example, a target recognition object such as a finger may be recognized by capturing the backlight reflected from the target recognition object.

In addition, in the first embodiment, although 16 levels, from level 1 to level 16 (the number of marked levels is 16), are employed for the size of the photo receiver PD, the number of the levels is not necessarily this number, and is not limited at all.

Furthermore, in the above-mentioned first embodiment, the display layer is formed of liquid crystal materials as a liquid crystal layer. However, the display layer is not limited to this, and may be formed of, for example, luminous elements as an organic EL display.

What is claimed is:

1. A display device comprising:
a plurality of scan lines and each of a plurality of signal lines which are provided intersecting to each other;
a plurality of display sections each disposed at an intersection of each of the plurality of scan lines and each of the plurality of signal lines; and
a plurality of photo receivers which are provided corresponding to the plurality of display sections so that the number of the disposed photo receivers would monotonically increase as the size of the photo receiver increase.

2. The display device according to claim 1, wherein the number of the plurality of disposed photo receivers monotonically increases on the basis of a linear function.

3. The display device according to claim 1, wherein the number of the plurality of disposed photo receivers monotonically increases on the basis of an exponential function.

4. A display device comprising:
a display area in which a plurality of pixel areas including a plurality of pixels are disposed;
a plurality of light sensors which are disposed in the pixel area, and which have the respectively different widths that increase in an arithmetical or geometrical series; and
a plurality of light sensors which have widths greater than or equal to the maximum width of the arithmetically or geometrically different widths of the light sensors provided in the pixel area.

5. The display device according to claim 4, wherein the number of light sensors having widths greater than or equal to the maximum width of the arithmetically or geometrically different widths is not less than ⅓ of the number of light sensors having the arithmetically or geometrically different widths.

6. The display device according to claim 4, wherein the plurality of light sensors respectively having the arithmetically or geometrically different widths, and the plurality of light sensors each having a width greater than or equal to the maximum width of the arithmetically or geometrically different widths are disposed at random in the pixel area.

7. The display device according to claim 5, wherein the plurality of light sensors respectively having the arithmetically or geometrically different widths, and the plurality of light sensors each having a width greater than or equal to the maximum width of the arithmetically or geometrically different widths are disposed at random in the pixel area.

8. The display device according to claim 4, further comprising a control circuit which adjusts an exposure time and/or precharge voltages of the light sensors according to the illumination intensity of outside light captured by the light sensors.

9. The display device according to claim 5, further comprising a control circuit which adjusts an exposure time and/or precharge voltages of the light sensors according to the illumination intensity of outside light captured by the light sensors.

10. The display device according to claim 6, further comprising a control circuit which adjusts an exposure time and/or precharge voltages of the light sensors according to the illumination intensity of outside light captured by the light sensors.

11. The display device according to claim 4, wherein transmittances of the plurality of pixels are equal to one another.

12. The display device according to claim 5, wherein transmittances of the plurality of pixels are equal to one another.

13. The display device according to claim 6, wherein transmittances of the plurality of pixels are equal to one another.

14. The display device according to claim 7, wherein transmittances of the plurality of pixels are equal to one another.

15. The display device according to claim 4, wherein:
the pixel includes sub-pixels of red, green and blue; and
the plurality of light sensors respectively having the arithmetically or geometrically different widths and the plurality of light sensors each having a width greater than or equal to the maximum width of the arithmetically or geometrically different widths are provided to at least one of the sub-pixels.

16. The display device according to claim 5, wherein:
the pixel includes sub-pixels of red, green and blue; and
the plurality of light sensors respectively having the arithmetically or geometrically different widths and the plurality of light sensors each having a width greater than or equal to the maximum width of the arithmetically or geometrically different widths are provided to at least one of the sub-pixels.

17. The display device according to claim 6, wherein:
the pixel includes sub-pixels of red, green and blue; and
the plurality of light sensors respectively having the arithmetically or geometrically different widths and the plurality of light sensors each having a width greater than or equal to the maximum width of the arithmetically or geometrically different widths are provided to at least one of the sub-pixels.

18. The display device according to claim 15, wherein the transmittances of the respective sub-pixels of red, green and blue are equal to one another.

19. The display device according to claim 8, wherein the control circuit adjusts the exposure time and/or the precharge voltages of the light sensors by replacing at least a part of sensor signal values from the plurality of light sensors respectively having the arithmetically or geometrically different widths, with sensor signal values from the plurality of light sensors each having a width greater than or equal to the maximum width of the arithmetically or geometrically different widths.
